(19) United States
(12) Patent Application Publication
(10) Pub. No.: US 2022/0131136 A1
(43) Pub. Date: Apr. 28, 2022

(54) ANODE MATERIAL FOR LITHIUM SECONDARY BATTERY AND METHOD FOR PRODUCING THE SAME

(71) Applicants: HYUNDAI MOTOR COMPANY, Seoul (KR); KIA CORPORATION, Seoul (KR); INCHEON NATIONAL UNIVERSITY RESEARCH & BUSINESS FOUNDATION, Incheon (KR)

(72) Inventors: Seung Min Oh, Incheon (KR); Ik Kyu Kim, Gwangmyeong-si (KR); Yeol Mae Yeo, Hwaseong-si (KR); Yoon Sung Lee, Suwon-si (KR); Ji Eun Lee, Hwaseong-si (KR); Sang Mok Park, Gwangju-si (KR); Dong Jun Kim, Seongnam-si (KR); Nam Hyeong Kim, Gimcheon-si (KR); Jun Young Mun, Incheon (KR); Yeong Don Park, Seoul (KR); Su Hyun Lee, Incheon (KR); Jun Hwa Park, Incheon (KR); Mei Hua Hong, Incheon (KR)

(73) Assignees: HYUNDAI MOTOR COMPANY, Seoul (KR); KIA CORPORATION, Seoul (KR); INCHEON NATIONAL UNIVERSITY RESEARCH & BUSINESS FOUNDATION, Incheon (KR)

(21) Appl. No.: 17/343,044

(22) Filed: Jun. 9, 2021

(30) Foreign Application Priority Data
Oct. 28, 2020 (KR) 10-2020-0141279

(51) Int. Cl. H01M 4/38; H01M 4/04

(52) U.S. Cl. CPC H01M 4/386; H01M 4/0471

(57) ABSTRACT

The anode material for a lithium secondary battery includes: an Si-based anode active material; and a film layer including a self-assembly monolayer (SAM) formed through bonding of SAM precursors onto a surface of the Si-based anode active material.

### CROSS REFERENCE TO RELATED APPLICATION

The present application claims priority and the benefit of Korean Patent Application No. 10-2020-0141279, filed on Oct. 28, 2020, the entire contents of which are incorporated herein by reference.

### FIELD

The present disclosure relates to an anode material for a lithium secondary battery and a method for producing the same.

### BACKGROUND

The statements in this section merely provide background information related to the present disclosure and may not constitute prior art.

A secondary battery has been used as a mass power storage battery of an electric car or a battery energy storage system and as a small high-performance energy source of a portable electronic device, such as a portable phone, a camcorder, or a notebook computer. Along with researches for component miniaturization and low power consumption aiming at the miniaturization and long-term continuous use of the portable electronic device, researches have been directed to the secondary battery which can realize a small size and high capacity.

In particular, as a representative secondary battery, a lithium secondary battery has a high energy density, large capacity per area, low self-discharge rate, and long lifespan in comparison to a nickel manganese battery or a nickel cadmium battery. Further, the lithium secondary battery has no memory effect, and thus has characteristics of convenience of use and long lifespan.

The lithium secondary battery produces an electric energy through a redox reaction when intercalation and deintercalation of lithium ions are performed at a cathode and an anode in a state where an electrolyte is filled between the cathode and the anode made of active materials capable of performing the intercalation and deintercalation of the lithium ions.

The lithium secondary battery as described above is composed of a cathode, an electrolyte, a separator, and an anode, and in order to secure the long lifespan and reliability of the battery, it is very important to stably maintain an interfacial reaction between the components.

Meanwhile, in the lithium secondary battery, the cathode is typically produced using a compound into which lithium, such as LiCoO₂ or LiMn₂O₄, is intercalated, and the anode is produced using a material into which carbon-based or Si-based lithium is not intercalated. During a charging operation, lithium ions intercalated into the cathode move to the anode through an electrolyte solution, and during a discharging operation, the lithium ions move again from the anode to the cathode.

The lithium moving from the cathode to the anode during a charging reaction forms a solid electrolyte interface (SEI) that is a kind of passivation film on the surface of the anode by a side reaction with the electrolyte solution. It is desirable that a thickness of the SEI formed as described above is provided such that ions are transferred but electrons are not transferred between the anode and the electrolyte.

Further, the SEI forming reaction is an irreversible reaction, and thus it causes consumption of the lithium ions. That is, the lithium consumed through forming of the SEI does not return to the cathode in a subsequent discharging process to reduce the capacity of the battery, and this phenomenon refers to an irreversible capacity. Further, since the charging/discharging efficiency of the cathode and the anode of the secondary battery is not completely 100%, consumption of the lithium ions occurs with the progress of the number of cycles, and the electrode capacity is reduced, resulting in the decrease in cycle lifespan. In particular, in case of using the Si-based material as the anode for the purpose of high capacity, an initial irreversible capacity becomes high, and this causes the low initial efficiency due to depletion of the lithium.

Therefore, in order to improve the performance of the lithium secondary battery, researches for improving an anode material have been steadily made.

In particular, in case of the Si-based anode material, there have been problems in that the volume increase of particles constituting the anode becomes severe during the charging operation when the lithium (Li) intercalation reaction occurs, whereas the particles collapse as the volume of the particles constituting the anode is decreased, and the SEI formed on the surface of the anode is deintercalated during the discharging operation when the lithium (Li) deintercalation reaction occurs.

Therefore, the inventor has completed the present disclosure considering that the problems occurring in the Si-based anode material during the charging/discharging operation) can be solved through the SAM surface control.

The foregoing is intended merely to aid in the understanding of the background of the present disclosure, and is not intended to mean that the present disclosure falls within the purview of the related art that is already known to those of ordinary skill in the art.

### SUMMARY

The present disclosure provides an anode material for a lithium secondary battery and a method for producing the same, which can reduce a side reaction at an anode through a SAM surface control with respect to an anode active material, and thus can improve energy efficiency.

According to one form of the present disclosure, an anode material for a lithium secondary battery includes an Si-based anode active material; and a film layer including a self-assembly monolayer (SAM) formed through bonding of SAM precursors onto a surface of the Si-based anode active material.

In one form, the Si-based anode active material may be any one or more of Si, SiO, and Si alloys.

In one form, the SAM precursors may be silane-based materials.

In one form, the SAM precursors may have a carbon chain length equal to or larger than a C8 chain length.

In one form, the SAM precursors may be made of trichloro(octyl)silane (OTS) or trichloro(octadodecyl)silane (ODTS).

In one form, a contact angle at the surface of the anode material may smaller than 61.56°.

According to another form of the present disclosure, a method for producing an anode material for a lithium secondary battery includes: preparing a Si-based anode active material and SAM precursors; and forming a film layer as a self-assembly monolayer (SAM) through bonding of the SAM precursors onto a surface of the prepared Si-based anode active material.

In the preparing step, the Si-based anode active material may be any one or more of Si, SiO, or Si alloys, and the SAM precursors may be silane-based materials having a carbon chain length equal to or larger than a C8 chain length.

It another form, the SAM precursors may be made of trichloro(octyl)silane (OTS) or trichloro(octadodecyl)silane (ODTS).

The forming of the film layer includes: depositing the SAM precursors on the surface of the Si-based anode active material under vacuum conditions; preserving the Si-based anode active material having a surface on which APS SAM precursor components are deposited at a room temperature; assembling the SAM precursors on the surface of the Si-based anode active material; and forming the film layer of the SAM precursors on the surface of the Si-based anode active material through annealing in a vacuum oven.

Since the film layer is formed on the surface of the anode active material through the SAM surface control, a solid electrolyte interface (SEI) of an atomic scale is formed on the surface of the anode, and thus the side reaction at the anode can be reduced and the energy efficiency of the anode can be improved.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic diagram showing an anode material for a lithium secondary battery according to one form of the present disclosure;

FIG. 2 shows structural formulas of SAM precursors being applied to an anode material for a lithium secondary battery according to one form of the present disclosure; and

FIGS. 3 to 7 are diagrams showing experimental results of an anode material according to comparative examples and forms.

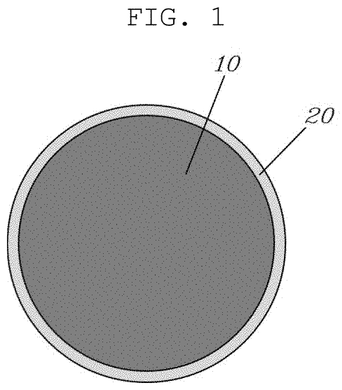

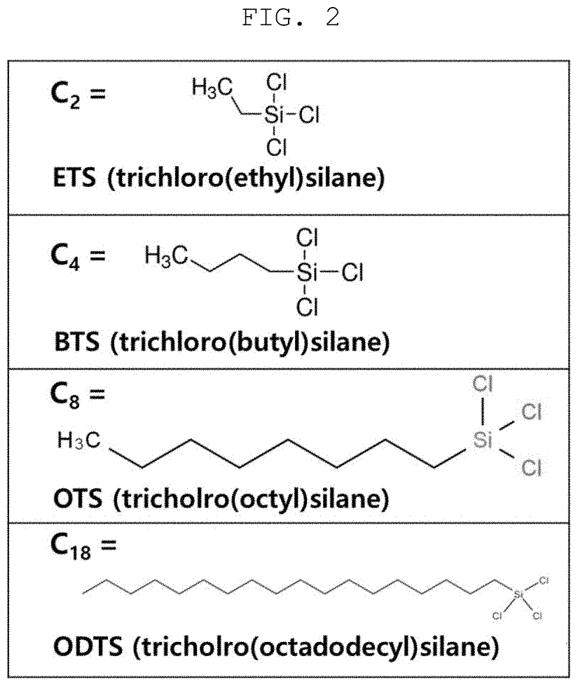

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

An anode material for a lithium secondary battery according to the present disclosure includes a Si-based anode active material; and a film layer formed on a surface of the Si-based anode active material.

The Si-based anode active material may be any one of or a combination of two or more of Si, SiO, and Si alloys.

The film layer is a passivation layer formed on the surface of the Si-based anode active material, and serves to transfer lithium ions and not to transfer electrons between the Si-based anode active material and an electrolyte.

For this, the film layer is formed as a self-assembly monolayer (SAM) through bonding of SAM precursors onto the surface of the Si-based anode active material. Accordingly, as a strong bond is formed between the Si-based anode active material and the SAM precursors, the volume change of the Si-based anode active material is reduced, and thus a solid electrolyte interface (SEI) deintercalation phenomenon is reduced.

Meanwhile, it is desirable that the film layer has the thickness that allows transfer of ions but not transfers of electrons.

For this, the SAM precursors used to form the film layer are silane-based materials.

For example, as the SAM precursors, trichloro(ethyl)silane (ETS), trichloro(butyl)silane (BTS), trichloro(octyl)silane (OTS), and trichloro(octadodecyl)silane (ODTS) may be used.

In particular, it is effective that the SAM precursors have a carbon chain length that is equal to or larger than a C8 chain length in order to maintain an excellent initial specific capacity. For this, the SAM precursors use trichloro(octyl)silane (OTS) or trichloro(octadodecyl)silane (ODTS).

Specifically, a discharge process of the lithium secondary battery is completed in a manner that Li⁺ ions moving from an anode to a cathode and free electrons being emitted in an ionization process and moving to the cathode through a wire meet each other and are bonded together. Accordingly, moving speeds of the Li⁺ ions and the electrons are important, and since the moving speed of the Li⁺ ions is lower than that of the electrons, the performance of the battery is determined by the moving speed of the Li⁺ ions. In case that the SAM is comprised of carbon chains less than C8, the density of the carbon chains is high due to a high packing density of dense alkyl chains, and thus it is difficult for the Li⁺ ions to get out, resulting in the increased resistance. Further, since a tunneling phenomenon of the electrons through the short SAM occurs, the electrons move out of the membrane without passing through the wire to induce a side reaction in the electrolyte solution, and thus stability of the battery is decreased.

In contrast, when the SAM carbon chains are long enough, the density of the carbon chains is relatively low due to a low packing density, and thus it becomes easy for the lithium ions to escape from the anode, whereas an electronic wall is thick enough to make the tunneling phenomenon difficult to occur, and thus the free electrons are not emitted into the electrolyte solution, resulting in the improved battery stability.

Meanwhile, since the film layer is formed by the SAM precursors having the carbon chain length equal to or larger than the C8 chain length, a contact angle at the surface of the anode material becomes smaller than 61.56°.

A method for producing an anode material formed as described above will be described.

A method for producing an anode material according to one form of the present disclosure includes: preparing an Si-based anode active material and SAM precursors; and forming a film layer as a self-assembly monolayer through bonding of the SAM precursors onto a surface of the prepared Si-based anode active material.

The preparing step is to prepare the Si-based anode active material and SAM precursors, and as described above, the Si-based anode active material is prepared as any one of or a combination of more of Si, SiO, or Si alloys, and the SAM precursors are prepared using silane-based materials.

In this case, as the SAM precursors, for example, trichloro(ethyl)silane (ETS), trichloro(butyl)silane (BTS), trichloro(octyl)silane (OTS), or trichloro(octadodecyl)silane (ODTS) may be used. Further, in order to maintain an excellent initial specific capacity, the SAM precursors having the carbon chain length that is equal to or larger than the C8 chain length, for example, trichloro(octyl)silane (OTS) or trichloro(octadodecyl)silane (ODTS) may be used.

Once the Si-based anode active material and the SAM precursors are prepared as above, the film layer is formed by coating the surface of the Si-based anode active material with the SAM precursors.

The forming of the film layer includes depositing SAM precursor components on the surface of the Si-based anode active material under vacuum conditions; preserving the Si-based anode active material having a surface on which APS SAM precursor components are deposited at a room temperature for 24 hours, and assembling the SAM precursor components on the surface of the Si-based anode active material; and performing a heat treatment process to form a film of the SAM precursor components on the surface of the Si-based anode active material through annealing in a vacuum oven.

In particular, the heat treatment process is performed for one hour under conditions of 130° C.

Next, the present disclosure will be described through comparative examples and forms.

First, in order to prepare anode material samples according to comparative examples and forms, an anode was prepared in accordance with the above-described method for producing an anode material.

In this case, for the sample according to the comparative example, SiO was used as the Si-based anode active material, and no treatment was performed with respect to the surface of the Si-based anode active material, so that the film layer was not formed.

For the samples according to one form, SiO was used as the Si-based anode active material, and as the material of the film layer formed on the surface of the Si-based anode active material, trichloro(ethyl)silane (ETS), trichloro(butyl)silane (BTS), trichloro(octyl)silane (OTS), and trichloro(octadodecyl)silane (ODTS) were used.

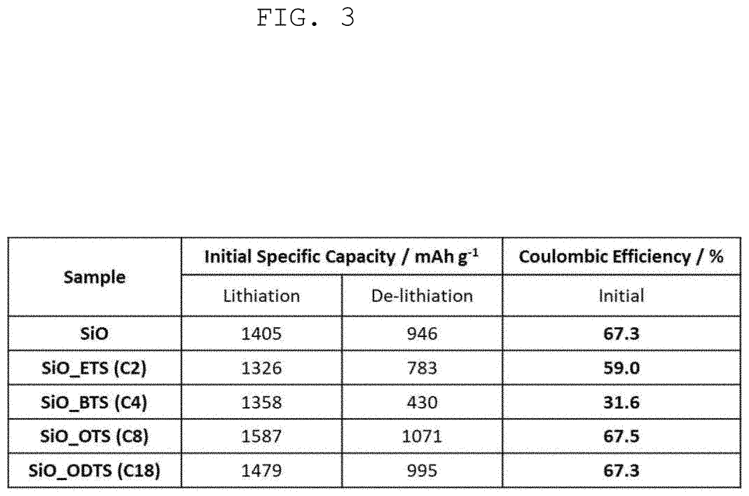

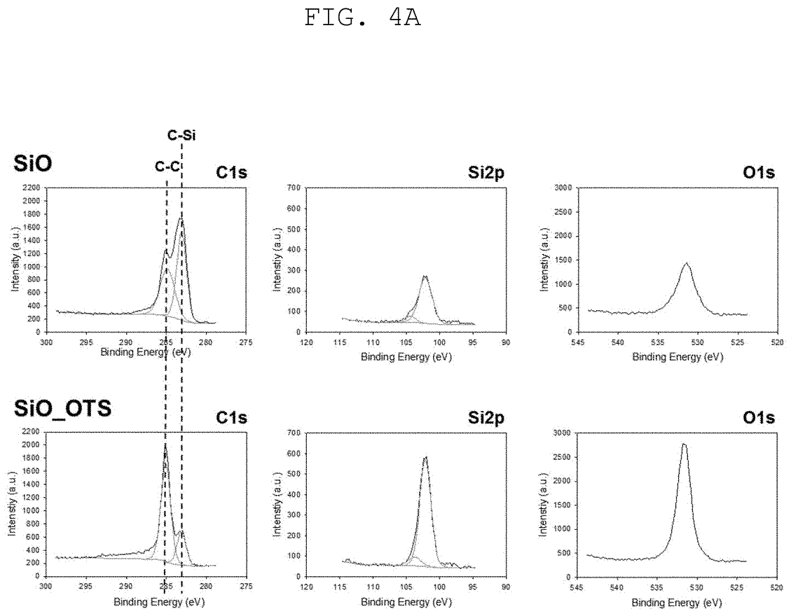

With respect to the samples as prepared above, the initial specific capacities were measured and the coulombic efficiencies were measured during charging/discharging, and the measurement results are represented in FIG. 3.

As shown in FIG. 3, it was confirmed that the initial specific capacities or coulombic efficiencies during the charging/discharging were similar to each other or were improved in the forms in which the film layer was formed using the SAM precursors compared to the comparative examples in which the SAM precursors were not used and thus the film layer was not formed.

In particular, among the forms, it was confirmed that the initial specific capacities or coulombic efficiencies during the charging/discharging were improved in the samples in which the OTS and ODTS having a relatively large carbon chain length were used as the SAM precursors compared to the samples in which the ETS and BTS having a relatively small carbon chain length were used as the SAM precursors. It was concluded that in case of the samples using the ETS and BTS having a small carbon chain length as the SAM precursors, the initial specific capacities and the coulombic efficiencies were decreased due to the high resistance.

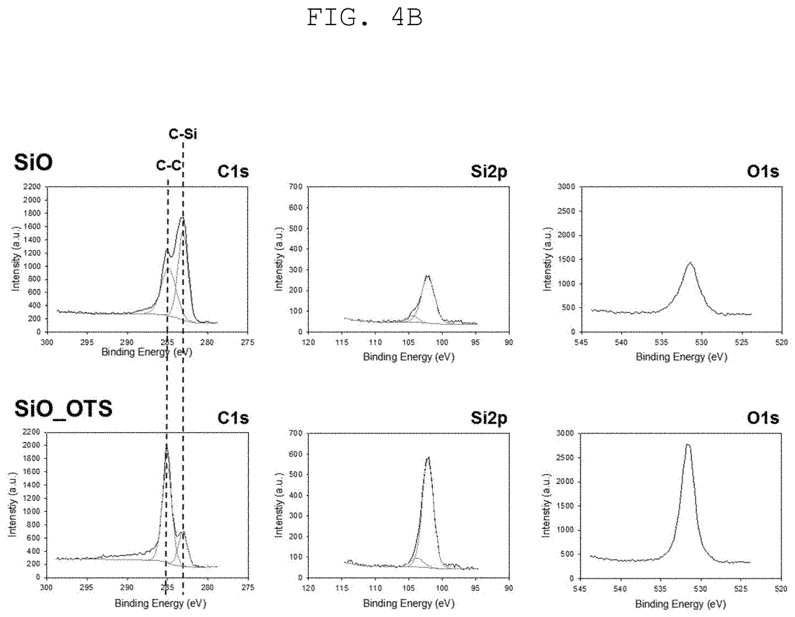

Next, FIGS. 4A and 4B are graphs showing the results of X-ray photoelectron spectroscopy (XPS) analyses with respect to the comparative examples in which the SAM precursors were not used and thus the film layer was not formed and the forms in which the OTS was used as the SAM precursors and thus the film layer was formed.

The XPS is a surface analysis method based on photoelectric effects, which measures a bond energy by measuring a kinetic energy of electrons of atoms of a sample. An X-ray is used as a light source to emit electrons of atoms of the sample. Since the interatomic bond energy is well known in the art, it is possible to confirm the atom-atom bond present on the surface through measurement of intensity. As a larger intensity value appears, a larger number of atoms form the bond.

FIG. 4A shows the results of top-most, and FIG. 4B shows the results of 3 sec etching.

As confirmed in FIGS. 4A and 4B, it was confirmed that the C—C peak was increased as the Si—C peak that was existing a lot in the anode active material was SAM-processed.

Specifically, the intensity of the C—C peak was increased whereas the intensity of the C—Si peak was decreased, and this was able to be interpreted to represent the results in that the anode surface was evenly processed with the material having several carbons through well reaction with the precursors to increase the intensity of the C—C bond, and the C—Si bond of the anode was covered with the SAM structure to decrease the intensity.

Further, it was able to be interpreted that the OTS reacted with the SiO on the anode surface to form the O—Si bond, and thus the Si peak and O peak were increased.

Further, in the embodiment in which the film layer was formed using the OTS as the SAM precursors, carbon of a long chain was confirmed.

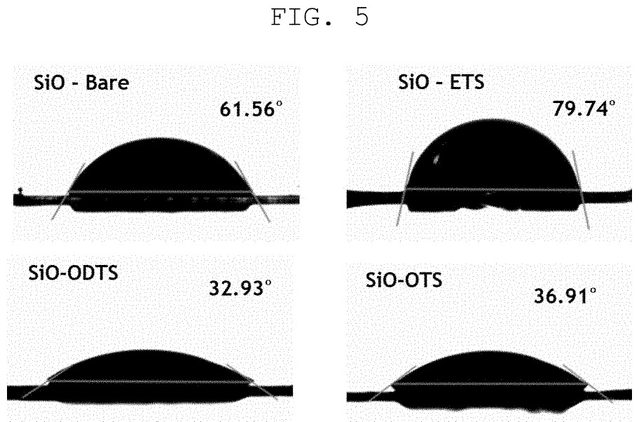

Next, contact angles on the surface of the sample according to the comparative examples and the embodiments were measured, and the measurement results are represented in FIG. 5.

As shown in FIG. 5, it was able to be confirmed that the contact angles on the surface were gradually increased in the order of a sample in which the ODTS was used as the SAM precursors, a sample in which the OTS was used as the SAM precursors, a sample in which the SAM precursors were not used, and a sample in which the ETS was used as the SAM precursors.

Since the contact angle becomes gradually smaller as the chain becomes longer, the contact angle becomes larger as the chain becomes shorter, and the movement of the Li⁺ ions is hindered due to the high packing density. With reference to FIGS. 3 and 5, it can be confirmed that the battery performance is degraded in case that the SAM structure is formed by SiO_ETS and SiO_BTS rather than the SiO_Bare state. In contrast, since the movement of the Li⁺ ions becomes easier due to the low packing density as the chain becomes longer, it can be confirmed that the battery performance is improved.

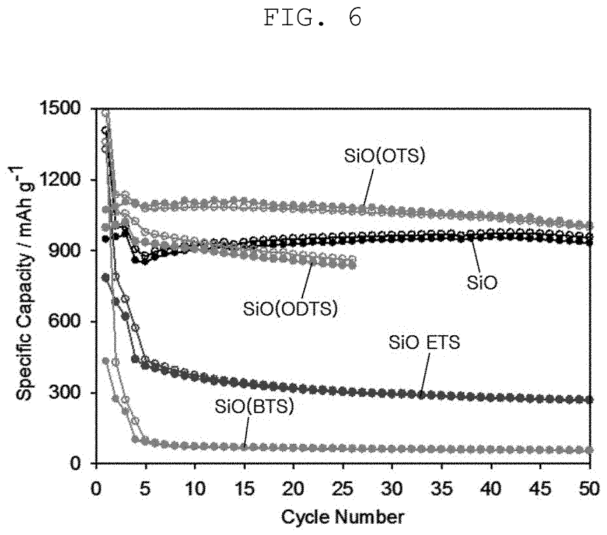

Next, the lifespan curves of the samples according to the comparative examples and the embodiments were measured and the measurement results are represented in FIG. 6.

As shown in FIG. 6, among the embodiments, it was able to be confirmed that the lifespan evaluation results were good in the samples in which the OTS and ODTS having a relatively large carbon chain length were used as the SAM precursors as compared with the samples in which the ETS and BTS having a relatively small carbon chain length were used as the SAM precursors.

It can be interpreted that the SAM structure having a long carbon chain formed on the anode surface protects the anode surface, and thus the lifespan of the battery is improved.

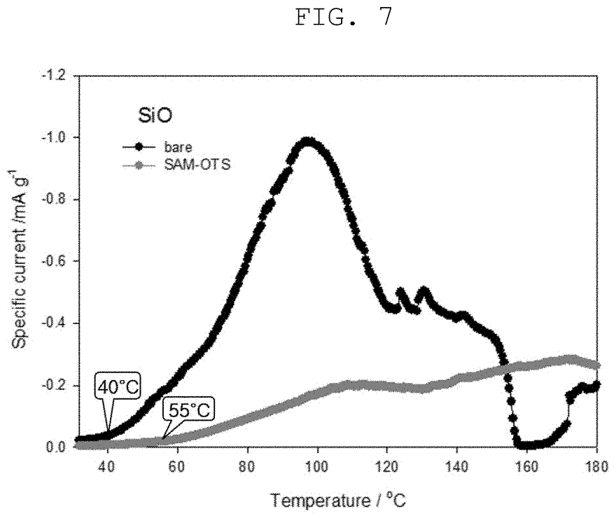

Next, the LSTA of the samples according to the comparative examples and the embodiments were measured and the measurement results are represented in FIG. 7.

In this case, the measurement conditions are as follows.

Step-1: 0.05C charge (cutoff at 0.05 mV)

Step-2: CV (cutoff at CA. 1050 mAh/g)

Step-3: LSTA (temperature sweep rate: 1° C./min)

As was able to be confirmed in FIG. 7, in case that the film layer is not formed, the current behavior starts to occur from 40° C., whereas in case that the film layer is formed by the OTS-SAM, the current behavior starts to occur from 55° C.

Although the specific embodiments of the present disclosure have been illustrated and described for illustrative purposes, those of ordinary skill in the art will appreciate that various modifications, additions and substitutions are possible, without departing from the scope and spirit of the invention as disclosed in the accompanying claims.

What is claimed is:

1. An anode material for a lithium secondary battery, the anode material comprising:
an Si-based anode active material; and
a film layer including a self-assembly monolayer (SAM) formed through bonding of SAM precursors onto a surface of the Si-based anode active material.

2. The anode material according to claim 1, wherein the Si-based anode active material comprises at least one of Si, SiO, or Si alloys.

3. The anode material according to claim 1, wherein the SAM precursors are silane-based materials.

4. The anode material according to claim 3, wherein the SAM precursors have a carbon chain length equal to or larger than a C8 chain length.

5. The anode material according to claim 4, wherein the SAM precursors are made of trichloro(octyl)silane (OTS) or trichloro(octadodecyl)silane (ODTS).

6. The anode material according to claim 1, wherein a contact angle at the surface of the anode material is smaller than 61.56°.

7. A method for producing an anode material for a lithium secondary battery, the method comprising:
preparing a Si-based anode active material and SAM precursors; and
forming a film layer as a self-assembly monolayer (SAM) through bonding of the SAM precursors onto a surface of the prepared Si-based anode active material.

8. The method according to claim 7, wherein:
the Si-based anode active material comprises at least one of Si, SiO, or Si alloys, and
the SAM precursors are silane-based materials having a carbon chain length equal to or larger than a C8 chain length.

9. The method according to claim 8, wherein the SAM precursors are made of trichloro(octyl)silane (OTS) or trichloro(octadodecyl)silane (ODTS).

10. The method according to claim 7, wherein forming the film layer comprises:
depositing the SAM precursors on the surface of the Si-based anode active material under vacuum conditions;
preserving the Si-based anode active material having a surface on which APS SAM precursor components are deposited at a room temperature;
assembling the SAM precursors on the surface of the Si-based anode active material; and
forming a film of the SAM precursors on the surface of the Si-based anode active material through annealing in a vacuum oven.
